(19) United States
(12) Patent Application Publication
(10) Pub. No.: US 2021/0045399 A1
(43) Pub. Date: Feb. 18, 2021

(54) Purified Animal Colostrum Nutritional Supplement

(71) Applicant: Sarah L. Rahal, Mahwah, NJ (US)

(72) Inventor: Sarah L. Rahal, Mahwah, NJ (US)

(21) Appl. No.: 16/993,632

(22) Filed: Aug. 14, 2020

Related U.S. Application Data
(60) Provisional application No. 62/886,516, filed on Aug. 14, 2019.

(51) Int. Cl. A23C 9/20; A23C 21/06; A23C 9/16; A23L 33/135; A23L 33/105; A23L 33/15; A23L 33/29; A23L 33/00

(52) U.S. Cl. CPC A23C 9/206; A23C 21/06; A23C 9/16; A23L 33/40; A23L 33/105; A23L 33/15; A23L 33/29; A23L 33/135

(57) ABSTRACT

Provided is a method of optimizing animal colostrum for human consumption by removing allergenic components and combining one or more immune factors to enable the composition to target the mucosal barriers, thereby enhancing mucosal integrity and increasing immune support. The composition is purified to remove one or more of lactose, casein proteins, fats, and/or oils, thereby creating a product that is devoid of allergenic components. The composition may be combined with a prebiotic, and/or natural sweeteners, additional vitamins, herbs, and/or minerals, and flavoring ingredients. The resulting product forms an instantly dissolvable powder that can be distributed in single serve packets, aerosolized spray, and/or in a chewable form. Furthermore, the composition can be used as an ingredient in food and beverages, in infant formula, in medical foods, or in over-the-counter drugs. Also provided is a method of manufacturing the bioactive composition.

### CROSS-REFERENCE TO RELATED APPLICATIONS

This application claims the benefit of U.S. Provisional Application No. 62/886516 filed on Aug. 14, 2019, entitled “Purified Animal Colostrum Nutritional Supplement”. The above identified patent application is herein incorporated by reference in its entirety to provide continuity of disclosure.

### FIELD OF THE INVENTION

The present invention relates to compositions and methods for improving immune health. More particularly, the present invention pertains to a method of optimizing animal colostrum for human consumption by removing allergenic components and combining or enhancing concentrations of one or more immune factors to enable the composition to target the mucosal barriers, thereby improving mucosal integrity and increasing immune support.

### BACKGROUND OF THE INVENTION

Colostrum is the first form of milk produced by the mammary glands of humans, cows, and other mammals immediately following delivery of a newborn, and is known as parturition. Colostrum is a yellow fluid rich in proteins, carbohydrates, fats, vitamins, minerals, and antibodies, and particularly contains an elevated concentration of immunoglobulins compared to normal milk. Survival of non-human newborn mammals is dependent on the ingestion and absorption of immunoglobulins during the first 24 hours after birth.

One of the main benefits of colostrum is the high antibody content, which can be 100 times higher than that which is found in mature milk. Humans are born without certain antibodies, namely sIgA, as they receive only IgG mediated immunity from the placenta before birth. Instead, these sIgA antibodies are ingested through colostrum, which is termed “passive immunization”. The antibodies ingested from the colostrum remain largely intact as they travel to the intestine, and therein afford protection to the newborn from infection by bacteria and other pathogens. Other mammals, conversely, do not receive IgG immunity through the placenta, and thus, their colostrum additionally contains high levels of this particular immunoglobulin in order to confer passive immunization to the infant.

Recent studies have shown a list of complications related to infants that are formula fed versus those that are breastfed. Infants that are formula fed are found to have a higher incidence of infectious morbidity, mortality, risks of childhood obesity, type 1 and type 2 diabetes, leukemia, atopic disease like allergies and asthma, and sudden infant death syndrome. Complications are further increased in premature infants, wherein not receiving breast milk also causes an increased risk of necrotizing enterocolitis.

In addition to the benefits that infants receive from colostrum, studies show that children and adults may also benefit from the ingestion of colostrum. The proteins found in colostrum have been shown to repair damage and to fortify the intestinal barrier. Disruption of this intestinal mucosal barrier has been linked with autoimmune disorders, allergies, a host of endocrinologic and neurologic disorders, and an increased susceptibility to infections. Additionally, colostrum has been shown to encourage the growth of beneficial bacteria in the microbiome, which protects this barrier and helps to break down food into digestible nutrients. The immunoglobulins in colostrum provide another layer of defense against pathogens and toxins. Also, colostrum contains growth factors and bioactive peptides that support the immune system and accelerate tissue repair.

One of the problems inherent to ingesting colostrum is related to the difficulty in obtaining it from a natural source. As discussed above, mammals only produce colostrum for the first few days after delivery of a newborn making it difficult to obtain. Additionally, colostrum contains lactose, which is a sugar found in milk and dairy products that many individuals are unable to digest. Importantly, colostrum also contains casein protein, which is the most common culprit in those with cow's milk allergy. While colostrum supplements are known and available to consumers, the inclusion of lactose and other potentially allergenic components in the composition prohibit some groups of individuals from being able to benefit from the use thereof.

Another problem inherent to ingesting colostrum derived from other mammals is that while human and non-human colostrum share many similarities, there are sufficient differences to limit their effectiveness. For example, cows require different concentrations and types of proteins, bioactive peptides, and milk oligosaccharides in order to support a growing calf as opposed to those required to support a growing human. This in turn means that whole bovine colostrum contains an excess of certain components that are not necessary for humans, and an insufficient amount of other components that are vital to human growth, development, and maturation of the mucosal barrier.

Therefore, a need exists for a colostrum supplement that can be readily used by individuals that are allergic or intolerant to the natural components contained therein. Additionally, a need exists for optimizing a supplement specifically for human health, and one that especially targets the particular mucosal immune pathways, given that there is such abundant evidence for the mucosal barrier as a first line of defense, interfacing with the environment, and impacting so many aspects of human physiology. It is clear from the above description that a need exists for a colostrum supplement that is devoid of potentially allergenic components and that enhances immune support and mucosal barrier strength in infants and adults.

### Description of the Prior Art

Various compositions and methods have been proposed for overcoming these challenges. For example, U.S. Pat. No. 5,064,674 A to Girsh et al. (hereinafter ‘Girsh’) discloses a hypoallergenic milk made from the ultrafiltered permeate of cow's milk, whey, or other milk fraction. The permeate is substantially free of cow's milk protein and fat. The permeate is supplemented with hypoallergenic protein, and optionally fat, vitamins and minerals to meet the minimum daily nutritional requirements for milk. The blended hypoallergenic milk is homogenized, pasteurized, flashed sterilized, and packaged into containers. Casein-free sweet whey may thus be effectively utilized as a substitute for whole or skim milk in the production of a hypoallergenic milk product. The Girsh invention, however, does not disclose optimizing animal colostrum for human consumption.

Additionally, WO 2013/148688 A1 (Abbott Laboratories) (hereinafter ‘Abbott’) discloses a nutritional composition comprising a pea protein component that provides from about 5% to about 25% of the protein component, a milk protein concentrate provides from about 50% to about 65% of the protein component, and a soy protein isolate provides from about 5% to about 35% of the protein component. Any carbohydrate or source thereof that is suitable for use in oral nutritional products and is compatible with the other ingredients of the inventive compositions can be used as the carbohydrate of the inventive nutrition shakes. Abbott, however, is silent regarding the use of animal colostrum devoid of allergenic components and optimized for human consumption.

Furthermore, U.S. Pat. No. 9,259,440 B2 (Bisgaard-Frantzen) discloses compositions, products, and methods for preventing, ameliorating and/or treating infections and other diseases utilizing compositions comprising germ free colostrum, synthetically multimerized immunoglobulins, or germ free colostrum enriched with synthetically multimerized immunoglobulins. The invention also relates to use of these compositions as a pharmaceutical for prophylactic or ameliorating treatment of infections and other diseases. In addition the invention comprises methods for production of said compositions. This composition, however, does not disclose combining one or more immune factors to optimize animal colostrum for human consumption in order to enable the composition to target the mucosal barrier.

While these prior art compositions and methods disclose the use of purified colostrum for treatment of disease, these compositions do not disclose a method of optimizing animal colostrum for human consumption by removing allergenic components and combining one or more immune factors to enable the composition to target the mucosal barrier, thereby enhancing mucosal integrity and increasing immune support.

Accordingly, there is a need in the art for a composition comprising animal colostrum that is optimized for human consumption. In this regard, the present invention substantially fulfills this need.

### SUMMARY OF THE INVENTION

The present invention overcomes the limitations inherent with known and disclosed colostrum supplements by providing a novel supplement that is optimized for human consumption and is devoid of potentially allergenic components. The composition comprises a raw animal colostrum that is purified utilizing various types of pasteurization, centrifugation, filtration, and evaporation. The purification steps remove one or more of lactose, casein proteins, fats, and oils from the raw material, thereby creating a final product that contains the essential components to afford gut/immune health, while removing those that may cause allergies or intolerance. The final product includes bioactive peptides, proteins, and oligosaccharides. In addition to removing allergenic components, the composition of the present invention combines one or more immune factors that are essential for optimizing human health. Specifically, it is formulated to target human mucosal integrity, the barrier system that interfaces the bloodstream with everything inhaled and ingested from the outside environment. It is a better match for human physiologic needs.

The bioactive purified composition may be preferably combined with other prebiotics, as well as natural sweetener (e.g., stevia and/or a sugar composite), additional vitamins, herbs, and/or minerals, and flavoring ingredients, which is then agglomerated with sunflower lecithin and/or instantized. The composition provides an instantly dissolvable powder that can be distributed in single serve packets, aerosolized powder, and/or in a chewable form. The composition is particularly designed to improve the mucosal barriers (i.e. along the mouth, nose, lungs, gut, and urinary/reproductive tract), and to support the immune system. The composition can be formulated for use as an ingredient in food and beverages, in infant formula, in medical foods, or in over-the-counter drugs. The present invention further discloses a method of manufacturing the bioactive composition.

The present invention substantially diverges from the compositions that are known and disclosed in the prior art and consequently it is clear that there is a need in the art for an improvement to existing colostrum supplements. In this regard the instant invention substantially fulfills these needs.

### Objects of the Invention

In view of the foregoing disadvantages inherent in the known types of colostrum supplements now present in the prior art, the present invention provides a method of optimizing animal colostrum for human consumption, wherein the same can be utilized for targeting the mucosal barrier, enhancing mucosal integrity and increasing immune support.

It is therefore an object of the present invention to provide a new and improved colostrum supplement for human consumption that has all of the advantages of the prior art and none of the disadvantages.

It is another object of the present invention to provide a colostrum supplement that is devoid of particular allergenic components.

Another object of the present invention is to provide a colostrum supplement that is purified to remove lactose, casein proteins, fats, and/or oils.

Yet another object of the present invention is to provide a colostrum supplement derived from animals that combines one or more immune factors to enable the composition to target the human mucosal barrier.

Another object of the present invention is to provide a colostrum supplement that is combined with a prebiotic, and/or natural sweeteners, additional vitamins, herbs, and/or minerals, and flavoring ingredients.

A final object of the present invention is to provide a colostrum supplement that results in an instantly dissolvable powder that can be distributed in single serve packets, aerosolized sprays, gummies, and/or in a chewable form, and can be used as an ingredient in food and beverages, in infant formula, in medical foods, or in over-the-counter drugs.

Other objects, features and advantages of the present invention will become apparent from the following detailed description.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows the components of the purified composition.

FIG. 2 shows the components of the purified composition, their limits, and the method of assessment.

FIG. 3 shows the final test results related to the microbial purity of the final composition.

### DETAILED DESCRIPTION OF THE INVENTION

Reference is made herein to the attached drawings. For the purposes of presenting a brief and clear description of the present invention, the preferred embodiment will be discussed as used as a supplement derived from animal colostrum for human consumption.

The methods and compositions of the present invention relate to an animal colostrum supplement that is optimized for human consumption. The composition is optimized in a twofold manner by removing allergenic components and by enhancing concentrations of one or more immune factors to enable the composition to target the mucosal barrier. The final product targets the human mucosal barrier, thereby enhancing mucosal integrity and increasing immune support. The composition prevents and/or treats conditions related to the disruption of the human mucosal barrier, including inflammation, allergic disease, infections and autoimmune conditions.

Many bioactive components found in colostrum are of particular importance to human health, and have been extensively studied. As a non-limiting example, secretory immunoglobulin A (SigA) confers passive immunity to newborn infants and is passed exclusively through human milk; predominantly, through colostrum. It is the predominant immunoglobulin present at mucosal surfaces. Research has demonstrated that bovine SigA is analogous to human SigA (Mach et al. ‘Secretory IgA, a major immunoglobulin in most bovine external secretions’, 1971. J. Immunol. 106:552-563), and elucidated its role in respiratory mucosal immunity, including excluding pathogen entry (Renegar et al. ‘Role of IgA versus IgG in the control of influenza viral infection in the murine respiratory tract’ 2004, J. Immunol. 173, 1978-1986). SigA also plays a significant role in human mucosal immune defense by 1) excluding pathogens from making contact with epithelial cells; 2) trapping pathogens on the luminal surface via lectin binding; 3) cross-reacting with a broad range of pathogens; 4) does not activate complement efficiently; 5) is resistant to host and microbial proteases; and 6) maintains homeostasis of commensal bacteria required for follicle development (Mak et al. ‘Mucosal and Cutaneous Immunity, The Immune Response’ 2006, Academic Press, 583-609).

Additionally, lactoferrin is a bioactive that plays an important role in human mucosal immunity by directly killing pathogens, inhibiting their binding and replication, and demonstrating an anti-inflammatory role. Lactoferrin also promotes barrier function at the mucosa. Several human studies have demonstrated lactoferrin's antiviral properties (van der Strate et al. ‘Antiviral activities of lactoferrin’ 2001, Antiviral. Res. 52, 225-239), and ability to reduce the incidence of infections like sepsis, GI and respiratory disease in infants (Manzoni et al. ‘Bovine lactoferrin supplementation for prevention of late-onset sepsis in very low-birth-weight neonates: A randomized Trial’ 2009, JAMA. 302:1421-1428; Ochoa et al. ‘Clinical studies of lactoferrin in children’ 2012 Biochem. Cell Biol. 90:457-467; Manzoni et al. ‘Bovine lactoferrin prevents invasive fungal infections in very low birth weight infants: A randomized controlled trial’ 2012, Pediatrics. 129:116-123).

Milk oligosaccharides are another important component in colostrum. Structurally, each oligosaccharide is built on a lactose backbone and is extended by the addition/combination of various molecules including galactose, fucose, sialic acid, and N-acetylglucosamine. Milk oligosaccharides pass largely intact to the colon where they serve as a prebiotic food source for the gut microbiome, thus encouraging populations of beneficial bacteria like bifidobacteria and lactobacilli. The benefit of milk oligosaccharides in human health include optimization of the intestinal microbiome, prevention of pathogen adhesion to the mucosa, antiviral activity, modulation of the intestinal epithelial cell response, and healthy immune system maturation (Wiciński et al. ‘Human Milk Oligosaccharides: Health Benefits, Potential Applications in Infant Formulas, and Pharmacology’ 2020, Nutrients, 12(1), 266). Research suggests milk oligosaccharides have a role in reducing the incidence of various infections, allergies (Seppo et al. ‘Human milk oligosaccharides and development of cow's milk allergy in infants’ 2017, J. Allergy Clin. Immunol. 139:708-11), auto-immune diseases, and inflammation (Vassilis et al. ‘Immunological Effects of Human Milk Oligosaccharides’ 2018 Frontiers in Pediatrics 6:190).

The composition preferably includes a bioactive composition of animal colostrum processed via minimal heat pasteurization, followed by removal of one or more of lactose, casein protein, water, fats and oils from the raw material. The colostrum may be derived from any mammal, however, the present invention contemplates use of colostrum from bovine, porcine, ovine, human, or combinations thereof. In the preferred embodiment, the colostrum may be derived from bovine. As is well understood, colostrum is produced by mammals at the end of pregnancy and during the first 2-5 days postpartum. As compared to mature milk, colostrum contains elevated amounts of carbohydrates, including lactose, protein, and antibodies, which are in the form of immunoglobulins (IgA, IgD, IgG, IgE, and IgM). The total amount of immunoglobulins in natural bovine colostrum may be between 10-30% of the total protein content in colostrum, with IgG counting for up 85-90% of the total immunoglobulin content. As can be appreciated, the IgG concentration in bovine colostrum is much higher than that which is found in human colostrum. Proteins found in colostrum include casein, lactoferrin, lactalbumin, lactoglobulin, lactoperoxidase, proline rich polypeptides (PRPs) and growth factors, such as IGFs. Additionally, colostrum includes fat, vitamins, ash, milk oligosaccharides, minerals, and nutrients.

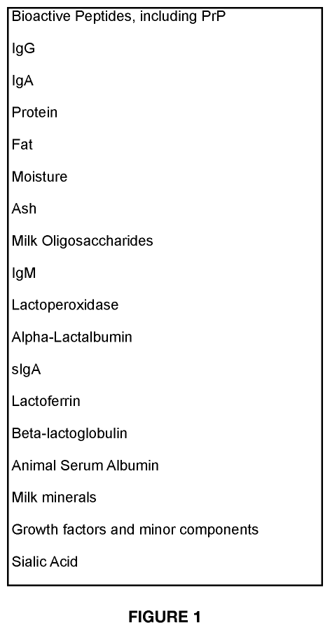

The colostrum can be collected by any method known in the art. Preferably, the colostrum is collected up to 24-72 hours postpartum. In some embodiments, lactose is removed, making the supplement optimal for consumption by lactose intolerant individuals. Alternately, the composition can be produced with lactose for use by individuals who are not sensitive to the sugar. With the removal of casein protein, water, fats/oil, and lactose, the final composition includes bioactive peptides, proteins, and oligosaccharides. In the preferred embodiment, the purified composition comprises the components listed in Table 1 and shown in FIG. 1.

TABLE 1
Components in the Composition

Bioactive Peptides, including PrP
IgG
IgA
Protein
Fat
Moisture
Ash
Milk Oligosaccharides
IgM
Lactoperoxidase
Alpha-Lactalbumin
sIgA
Lactoferrin
Beta-lactoglobulin
Animal Serum Albumin
Milk minerals
Growth factors and minor components
Sialic Acid

The components in the composition can be included in any percentage or w/w as desired. In the preferred embodiment, the composition includes Bioactive Peptides including PrP. In the preferred embodiment, the composition includes IgG. In the preferred embodiment, the composition includes IgA. In the preferred embodiment, the composition includes protein. In the preferred embodiment, the composition includes fat. In the preferred embodiment, the composition includes moisture. In the preferred embodiment, the composition includes Ash. In the preferred embodiment, the composition includes milk oligosaccharides. In the preferred embodiment, the composition includes IgM. In the preferred embodiment, the composition includes Lactoperoxidase. In the preferred embodiment, the composition includes Alpha-Lactalbumin. In the preferred embodiment, the composition includes water. In the preferred embodiment, the composition includes sIgA. In the preferred embodiment, the composition includes Lactoferrin. In the preferred embodiment, the composition includes Beta-lactoglobulin. In the preferred embodiment, the composition includes Animal Serum Albumin. In the preferred embodiment, the composition includes milk minerals. In the preferred embodiment, the composition includes growth factors and minor components. In the preferred embodiment, the composition includes sialic acid.

In one embodiment, the composition comprises the following components in the following amounts: IgG in the range of 0-40%, IgA in the range of 0-40%, protein in the range of 0-40%, fat in the range of 0-40%, moisture in the range of 0-40%, ash in the range of 0-40%, and oligosaccharide containing carbohydrates in the range of 0-40%. In another embodiment, the composition comprises the following components in the following amounts: IgG at a concentration of 30%, IgA at a concentration of 1.5%, protein at a concentration of 55%, fat at a concentration of 5%, moisture at a concentration of 5%, ash at a concentration of 10%, and oligosaccharide containing carbohydrates at a concentration of 30%.

In the preferred embodiment, the composition comprises the following components in the following amounts: IgG at a concentration of 32%, IgA at a concentration of 2%, protein at a concentration of 64%, fat at a concentration of 2%, moisture at a concentration of 4.8%, ash at a concentration of 5.5%, and oligosaccharide containing carbohydrates at a concentration of 24%.

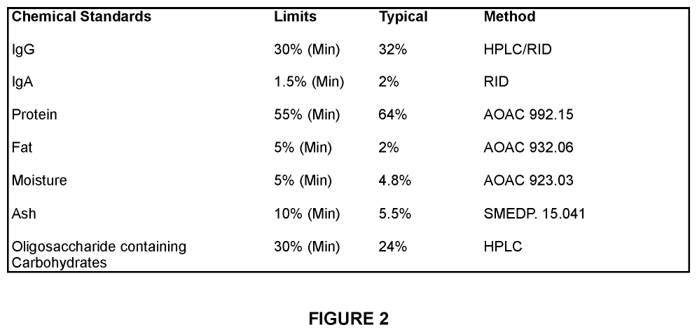

The purified composition comprises the components and their percentages as listed in Table 2 and shown in FIG. 2.

TABLE 2
Preferred Components in the Composition and their Percentages

| Chemical Standards | Limits | Typical | Method |
|---|---|---|---|
| IgG | 30% (Min) | 32% | HPLC/RID |
| IgA | 1.5% (Min) | 2% | RID |
| Protein | 55% (Min) | 64% | AOAC 992.15 |
| Fat | 5% (Min) | 2% | AOAC 932.06 |
| Moisture | 5% (Min) | 4.8% | AOAC 923.03 |
| Ash | 10% (Min) | 5.5% | SMEDP. 15.041 |
| Oligosaccharide | 30% (Min) | 24% | HPLC |
| containing | | | |
| Carbohydrates | | | |

The limits of the various components in the purified composition of the present invention are optimized for human use. As compared to the natural components and their limits in bovine colostrum, as shown in Table 3, it is evident that the optimization method causes the limits or percentages of components to differ substantially from their natural limits. As can be appreciated, the optimization causes the components to be present in amounts that are ideal for targeting the human mucosal barrier.

TABLE 3
Typical components and percentages in bovine colostrum
(Biodane Phamra, ‘Contents in bovine colostrum’
(https://biodanepharma.info/contents-in-bovine-colostrum).

| Bovine Colostrum | Limits | |
|---|---|---|
| IgG1 | 34.0-87.0 | μg/L |
| IgG2 | 1.6-6.0 | μg/L |
| IgA | 1.7-6.2 | μg/L |
| Fat | 6.7% | |
| Ash | 16442.7 | mg/kg |

| | |
|---|---|
| Oligosaccharide | 2.5% |
| containing | |
| Carbohydrates | |

In an alternate embodiment, the composition comprises the following components in the following amounts: Bioactive Peptides including PrP at a concentration of 8.40%, IgG at a concentration of 37.35%, IgM at a concentration of 3.27%, Lactoperoxidase at a concentration of 0.19%, Alpha-Lactalbumin at a concentration of 6.72%, water at a concentration of <7.42%, sIgA at a concentration of 4.20%, Lactoferrin at a concentration of 0.37%, Beta-lactoglobulin at a concentration of 14.01%, Animal Serum Albumin at a concentration of 2.43%, milk minerals at a concentration of 14.57%, growth factors and minor components at a concentration of 1.03%, and milk oligosaccharides at a concentration of 1.00%. The purified composition comprises the components and percentages thereof as listed in Table 4.

TABLE 4
Components in the Composition

| | |
|---|---|
| Bioactive Peptides including PrP | 8.40% |
| IgG | 37.35% |
| IgM | 3.27% |
| Lactoperoxidase | 0.19% |
| Alpha-Lactalbumin | 6.72% |
| Water | <7.47% |
| sIgA | 4.20% |
| Lactoferrin | 0.37% |
| Beta-lactoglobulin | 14.01% |
| Animal Serum Albumin | 2.43% |
| Milk minerals | 14.57% |
| Growth factors and minor components | 1.03% |
| Milk Oligosaccharides | 1.00% |

In an alternate embodiment, the purified composition comprises the following components in the following ranges: Bioactive Peptides including PrP in the range of 0-40%, IgG in the range of 0-60%, IgM in the range of 0-40%, Lactoperoxidase in the range of 0-40%, Alpha-Lactalbumin in the range of 0-40%, water in the range of 0-10%, sIgA in the range of 0-40%, Lactoferrin in the range of 0-40%, Beta-lactoglobulin in the range of 0-40%, Animal Serum Albumin in the range of 0-40%, milk minerals in the range of 0-40%, growth factors and minor components in the range of 0-40%, and milk oligosaccharides in the range of 0-40%. The components and percentages thereof as listed in Table 5.

TABLE 5
Components in the Composition

| | |
|---|---|
| Bioactive Peptides including PrP | 0-40% |
| IgG | 0-60% |
| IgM | 0-40% |
| Lactoperoxidase | 0-40% |
| Alpha-Lactalbumin | 0-40% |
| Water | 0-10% |
| sIgA | 0-40% |
| Lactoferrin | 0-40% |
| Beta-lactoglobulin | 0-40% |
| Animal Serum Albumin | 0-40% |
| Milk minerals | 0-40% |
| Growth factors and minor components | 0-40% |
| Milk Oligosaccharides | 0-40% |

The method of manufacturing the composition comprises the steps of pasteurization, centrifuging, filtration, and evaporation. In the preferred embodiment, the raw animal colostrum undergoes HTST and/or VAT pasteurization. As can be appreciated, HTST, or high temperature short time pasteurization rapidly brings the product to a high temperature, holds it at temperature for a short period, and rapidly cools the composition. Additionally, VAT, or batch pasteurization, heats the product at 145° F. (63° C.) for 30 minutes. The pasteurization process destroys all disease-producing bacteria, as well as 90-99% of all other bacteria that may affect product quality. The type and time of pasteurization can be readily determined by one of skill in the art, and can be carried out based on the desired final product. Such pasteurization processes are then followed by in-direct heat spray drying.

The centrifuging step separates the components of the colostrum based on the sedimentation principle. Centrifuging is particularly useful for removing casein from the raw material. The type and time for centrifugation can be readily determined by one of skill in the art, and can be carried out based on the desired components to be included in the final product.

Purification, likewise, can be used to remove one or more of lactose, casein protein, fats, and oils from the raw material. As can be appreciated, a variety of purification protocols are known and can be used to remove components from the colostrum. The type of purification can be readily determined by one of skill in the art, and can be carried out based on the desired components to be included in the final product.

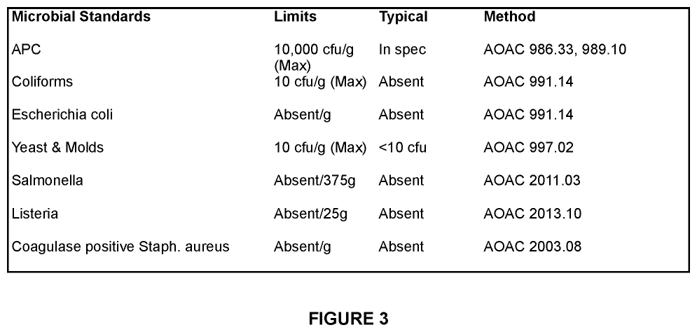

It is desirable that the final product is free of allergens and contaminants. In example 1, the final product as listed in Table 1 above was subjected to AOAC analysis for contaminants. The results are provided in Table 6 and shown in FIG. 3.

TABLE 6
Microbial Standards

| Microbial Standards | Limits | Typical | Method |
|---|---|---|---|
| APC | 10,000 cfu/g (Max) | In spec | AOAC 986.33, |
| | | | 989.10 |
| Coliforms | 10 cfu/g (Max) | Absent | AOAC 991.14 |
| Escherichia coli | Absent/g | Absent | AOAC 991.14 |
| Yeast & Molds | 10 cfu/g (Max) | <10 cfu | AOAC 997.02 |
| Salmonella | Absent/375 g | Absent | AOAC 2011.03 |
| Listeria | Absent/25 g | Absent | AOAC 2013.10 |
| Coagulase positive | Absent/g | Absent | AOAC 2003.08 |
| Staph. aureus | | | |

Once the steps of pasteurization, centrifugation, and purification are complete, the composition is devoid of one or more of lactose, casein protein, fats, and oils. What remains are bioactive peptides, proteins, and oligosaccharides. The purified composition can then optionally be combined with a prebiotic, a natural sweetener (i.e., stevia and/or a sugar composite), and flavoring, and/or other vitamin and minerals, and can then be agglomerated with sunflower lecithin.

The final filtrate is preferably combined with other ingredients. In a non-limiting embodiment, the final filtrate is combined with additional prebiotic fiber. In a non-limiting embodiment, the final filtrate is combined with a natural sweetener selected from stevia, monkfruit, and sugar. In a non-limiting embodiment, the final filtrate is combined with additional vitamins, herbs and micronutrients. In a non-limiting embodiment, the final filtrate is combined with flavoring ingredients. Following the addition of other ingredients, the composition preferably undergoes agglomeration with sunflower lecithin in order to produce a water dispersible powder.

I claim:

1. A method of optimizing animal colostrum for human consumption, comprising: removing allergenic components comprising one or more of lactose, casein proteins, fats, and oils, and combining immune factors to formulate a composition comprising bioactive peptides including PrP, IgG, IgA, protein, fat, moisture, ash, milk oligosaccharides, IgM, Lactoperoxidase, Alpha-Lactalbumin, sIgA, Lactoferrin, Beta-lactoglobulin, Animal Serum Albumin, milk minerals, growth factors and minor components, and sialic acid, wherein said optimized composition targets the mucosal barrier.

2. The method of claim 1, wherein said composition comprises PrP in the range of 0-40%, IgG in the range of 0-60%, IgA in the range of 0-40%, protein in the range of 0-40%, fat in the range of 0-40%, moisture in the range of 0-10%, ash in the range of 0-40%, milk oligosaccharides in the range of 0-40%, IgM in the range of 0-40%, Lactoperoxidase in the range of 0-40%, Alpha-Lactalbumin in the range of 0-40%, moisture in the range of 0-10%, sIgA in the range of 0-40%, Lactoferrin in the range of 0-40%, Beta-lactoglobulin in the range of 0-40%, Animal Serum Albumin in the range of 0-40%, milk minerals in the range of 0-40%, and growth factors and minor components in the range of 0-40%.

3. The method of claim 1, wherein said composition comprises PrP at a concentration of 8.40%, IgG at a concentration of 37.35%, IgM at a concentration of 3.27%, Lactoperoxidase at a concentration of 0.19%, Alpha-Lactalbumin at a concentration of 6.72%, sIgA at a concentration of 4.20%, Lactoferrin at a concentration of 0.37%, Beta-lactoglobulin at a concentration of 14.01%, Animal Serum Albumin at a concentration of 2.43%, milk minerals at a concentration of 14.57%, growth factors and minor components at a concentration of 1.03%, and milk oligosaccharides at a concentration of 1.00%.

4. The method of claim 1, wherein said composition is combined with a prebiotic, and/or natural sweeteners, additional vitamins, herbs, and/or minerals, and flavoring ingredients.

5. The method of claim 1, wherein said composition comprises an instantly dissolvable powder that can be distributed in single serve packets, and/or in a chewable form.

6. The method of claim 1, wherein said composition comprises an ingredient in food and beverages, in infant formula, in medical foods, or in over-the-counter drugs.

7. A method of optimizing animal colostrum for human consumption, comprising: removing allergenic components comprising one or more of lactose, casein proteins, fats, and oils, and combining immune factors, wherein said optimized composition targets the mucosal barrier.

8. The method of claim 7, wherein said immune factors comprise IgG, IgA, protein, fat, moisture, ash, and oligosaccharide containing carbohydrates.

9. The method of claim 7, wherein said immune factors comprise IgG at a concentration of 32%, IgA at a concentration of 2%, protein at a concentration of 64%, fat at a concentration of 2%, moisture at a concentration of 4.8%, ash at a concentration of 5.5%, and oligosaccharide containing carbohydrates at a concentration of 24%.

10. The method of claim 7, wherein said composition comprises PrP at a concentration of 8.40%, IgG at a concentration of 37.35%, IgM at a concentration of 3.27%, Lactoperoxidase at a concentration of 0.19%, Alpha-Lactalbumin at a concentration of 6.72%, sIgA at a concentration of 4.20%, Lactoferrin at a concentration of 0.37%, Beta-lactoglobulin at a concentration of 14.01%, Animal Serum Albumin at a concentration of 2.43%, milk minerals at a concentration of 14.57%, growth factors and minor components at a concentration of 1.03%, and milk oligosaccharides at a concentration of 1.00%.

11. The method of claim 7, wherein said composition is combined with a prebiotic, and/or natural sweeteners, additional vitamins, herbs, and/or minerals, and flavoring ingredients.

12. The method of claim 7, wherein said composition comprises an instantly dissolvable powder that can be distributed in single serve packets, and/or in a chewable form.

13. The method of claim 7, wherein said composition comprises an ingredient in food and beverages, in infant formula, in medical foods, or in over-the-counter drugs.

14. A method of optimizing animal colostrum for human consumption, comprising: removing allergenic components comprising one or more of lactose, casein proteins, fats, and oils, and combining immune factors comprising PrP in the range of 0-40%, IgG at a concentration of 32%, IgA at a concentration of 2%, protein at a concentration of 64%, fat at a concentration of 2%, moisture at a concentration of 4.8%, ash at a concentration of 5.5%, and oligosaccharide containing carbohydrates at a concentration of 24%, IgM in the range of 0-40%, Lactoperoxidase in the range of 0-40%, Alpha-Lactalbumin in the range of 0-40%, water in the range of 0-10%, Lactoferrin in the range of 0-40%, Beta-lactoglobulin in the range of 0-40%, Animal Serum Albumin in the range of 0-40%, milk minerals in the range of 0-40%, and growth factors and minor components in the range of 0-40%, wherein said optimized composition targets the mucosal barrier.

15. The method of claim 14, wherein said composition is combined with a prebiotic, and/or natural sweeteners, additional vitamins, herbs, and/or minerals, and flavoring ingredients.

16. The method of claim 14, wherein said composition comprises an instantly dissolvable powder that can be distributed in single serve packets, and/or in a chewable form.

17. The method of claim 14, wherein said composition comprises an ingredient in food and beverages, in infant formula, in medical foods, or in over-the-counter drugs.
